(19) United States
(12) Patent Application Publication
(10) Pub. No.: US 2009/0266691 A1
(43) Pub. Date: Oct. 29, 2009

(54) MOBILE TERMINAL DEVICE

(75) Inventors: Toshikazu ISHIOKA, Kawasaki (JP); Hiroyuki Takita, Kawasaki (JP); Manabu Matsushima, Kawasaki (JP); Yoshifumi Kajiwara, Kawasaki (JP); Kenta Sugimori, Kawasaki (JP); Kazunobu Yoneyama, Kawasaki (JP); Hiroshi Kubo, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/396,945

(22) Filed: Mar. 3, 2009

(30) Foreign Application Priority Data
Mar. 31, 2008 (JP) 2008-093087

(51) Int. Cl. H01H 9/00

(52) U.S. Cl. 200/310

(57) ABSTRACT

A mobile terminal device includes a movable side housing and a fixed side housing connected to the movable side housing with a connection part. The fixed side housing includes an operation panel in which a plurality of numeric keys are arranged, a light emitting elements that are provided at one end side of the operation panel, and a light guiding sheet member that guides light emitted from the light emitting element to a lower position of the operation panel and diffuses the light in a surface shape.

### CROSS-REFERENCE TO RELATED APPLICATIONS

This application is based upon and claims the benefit of priority of the prior Japanese patent application No. 2008-093087, filed on Mar. 31, 2008, the entire contents of which are incorporated herein by reference.

### FIELD

The present invention relates to a mobile terminal device provided with an operation panel in a fixed side housing. The present invention relates to a mobile terminal device that y efficiently illuminates the operation panel having, for example, an operation key such as a numeric key by a small number of light emitting element(s).

### BACKGROUND

For example, Japanese Laid-Open Patent Publication No. 06-318897 discloses an illumination device that illuminates the numeric key allocated in this operation panel by a multi-color emitting backlight or the like when the key of the operation panel is operated. In this manner, the conventional mobile phone may provide operability in the dark and visual operability by illuminating the numeric key for a certain time period when the key is operated.

However, to evenly illuminate a plurality of numeric keys allocated in the operation panel, the conventional mobile phone allocates a plurality of light emitting elements near the plurality of numeric keys. The light emitting element is, for example, an LED. Accordingly, the conventional mobile phone has a problem that the cost of making the same increases due to the increase in the number of components required.

Recently, there has been a problem that allocating a plurality of LEDs in the mobile phone increases the height (size) of the device, so that the mobile phone may not be slim. Therefore, it is desired to achieve a mobile phone that efficiently illuminates the numeric key of the operation panel by the small number of LEDs.

### SUMMARY

Accordingly, it is an object in one aspect of the present invention to provide a mobile terminal device that effectively illustrates a panel screen of an operation panel and reduces a number of component(s) of the light emitting element to be used.

According to an aspect of the invention, a mobile terminal device includes a movable side housing and a fixed side housing connected to the movable side housing with a connection part. The fixed side housing includes an operation panel in which a plurality of numeric keys are arranged, a light emitting element that are provided at one end side of the operation panel, and a light guiding sheet member that guides light emitted from the light emitting element to a lower position of the operation panel and diffuses the light in a surface shape.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a perspective diagram illustrating a patulous state of a mobile phone according to an embodiment;

FIG. 2 is an exploded perspective diagram illustrating an inner part of a fixed side front case included in a fixed side housing;

FIG. 3 is a perspective diagram illustrating a combination of a light guiding sheet, a dome sheet, and a circuit board;

FIG. 4 is an explanatory diagram explaining an attached state of a light shielding sheet; and

FIG. 5 is an enlarged cross-section diagram of a main part of FIG. 1.

### DESCRIPTION OF EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

With reference to the attached figures, description will be made below of a mobile terminal device according to an embodiment. The embodiment illustrates an application example of a mobile phone as a mobile terminal device.

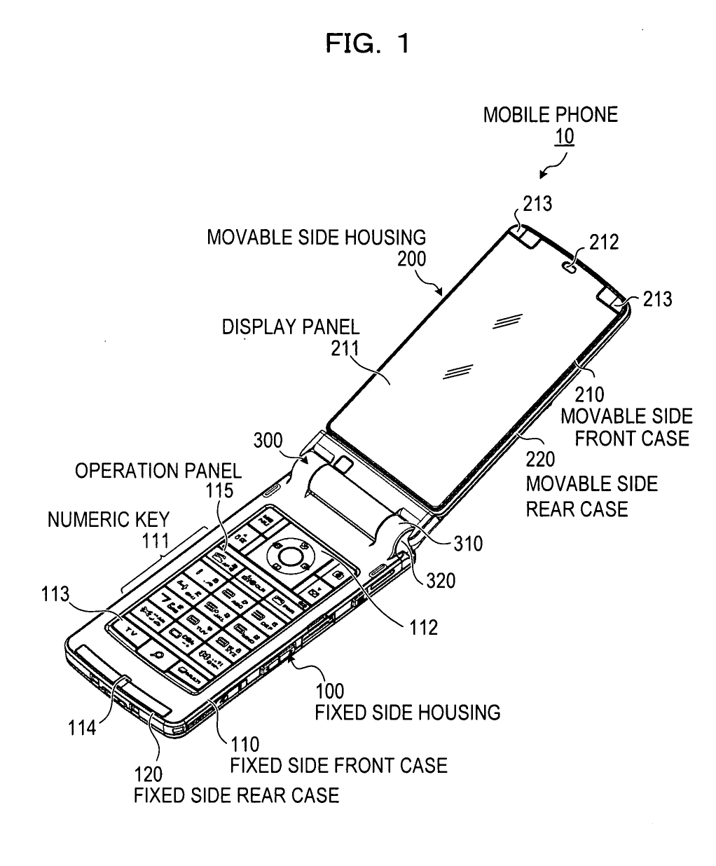

By using FIG. 1, an entire configuration of the mobile terminal device will be described. FIG. 1 is a perspective diagram illustrating an open state of the mobile phone according to an embodiment. As illustrated in FIG. 1, a mobile phone 10 is formed by connecting a movable side housing 200 and a fixed side housing 100 by a connection part 300. As illustrated in FIG. 1, the fixed side housing 100 may be palm-sized.

The mobile phone 10 includes a numeric key 111 having numeric keys on which the numbers, 0 to 9, are described and a fixed side housing 100 having, for example, various operation keys such as a function key 112 performing mode setting. The mobile phone 10 is formed by foldably connecting the fixed side housing 100 and the movable side housing 200 having an LCD module formed in a similar size to that of the fixed side housing 100 by the connection part 300 having two hinges 310 and 320.

The fixed side housing 100 and the movable side housing 200 are formed in a box shape. The material includes, for example, lightweight and high-strength magnesium alloy.

The fixed side housing 100 has a two-secton structure having a fixed side front case 110 in which an operation panel 115 with various operation keys such as the numeric key 111 are arranged and a fixed side rear case 120 positioned on the back side thereon.

The fixed side front case 110 has the above-described numeric key 111, the function key 112, a videophone key 113, and a mouthpiece 114 in which a microphone converting voice of a user into an electric signal is provided therein. The fixed side front case 110 and the fixed side rare case 120 are fixed at (four) positions respectively by screws.

The movable side housing 200 has a two-section structure having a movable side front case 210 positioned at a side of a display panel 211 and a movable side rear case 220 positioned on the back side. The upper part of the movable side front case 210 is provided with an earpiece 212 using which a user of the mobile phone 10 listens to voice. While particular keys and components of the device are described, the present invention is not limited to a mobile terminal device having these specific keys and/or components.

Both the movable front case 210 and the movable side rear case 220 are also fixed at (four) positions respectively by screws. The upper position of the display panel 211 is provided with blind covers 213 for the screws.

In the mobile phone 10 according to an embodiment, the fixed side housing 100 allocates two light emitting elements (LED) 700 at one end side of the operation panel 115 in which a plurality of numeric keys 111 are arranged. The fixed side housing 100 guides the light emitted from the light emitting element 700 to a lower position of the operation panel 115 and has a light guiding sheet member 400 that diffuses the light in a surface shape. Details of the light guiding sheet member 400 and the light shielding sheet 350 are explained below in detail.

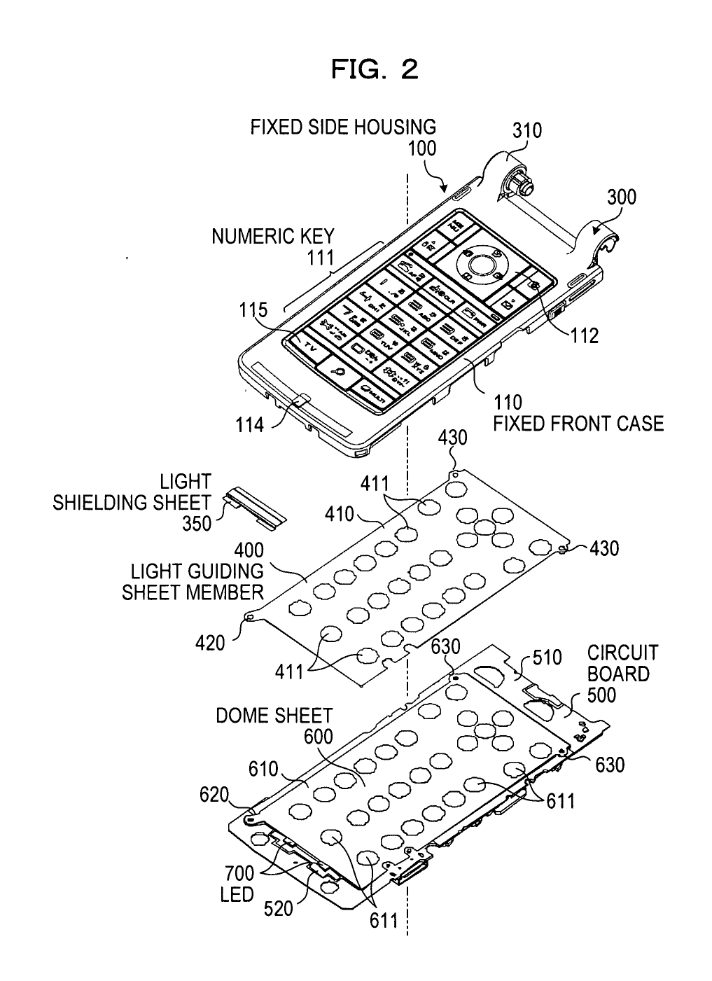

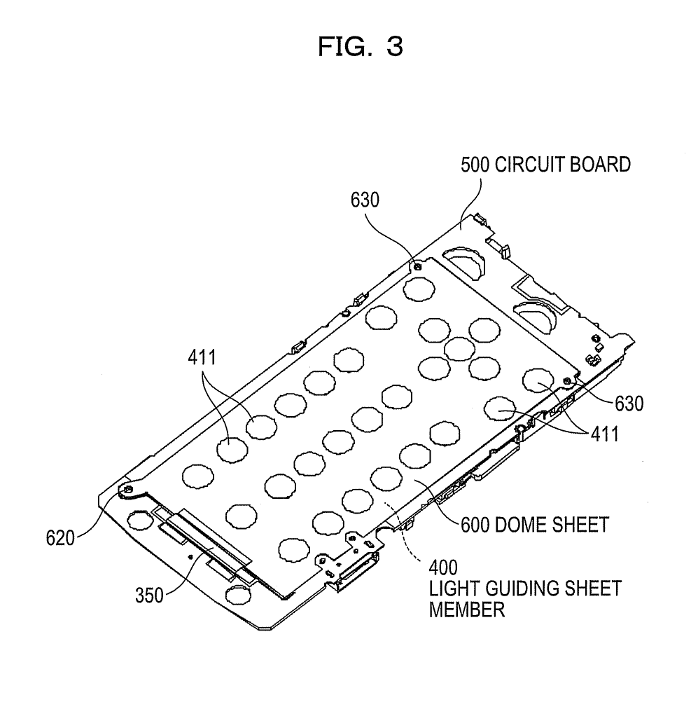

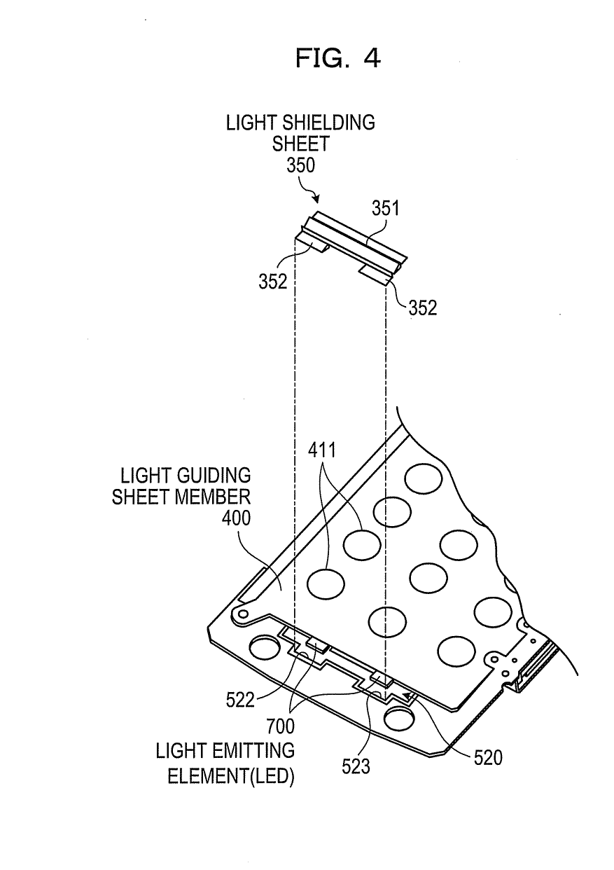

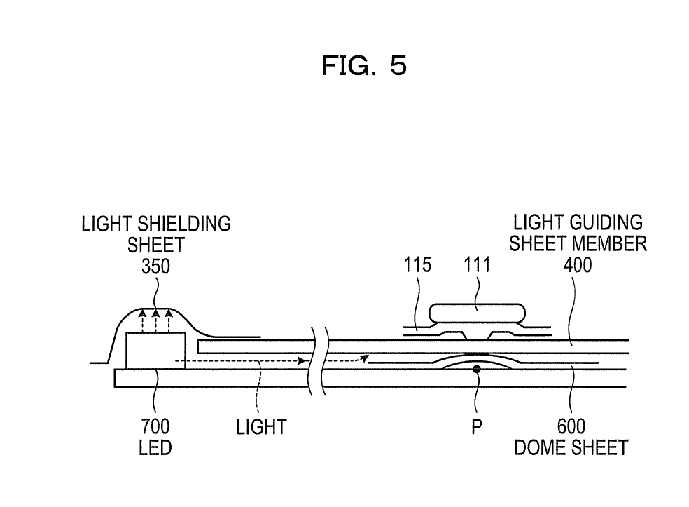

By using FIG. 2 to FIG. 5, detailed description will be made of the light guiding sheet member 400 and a light shielding sheet 350 that are provided in an inner part of the fixed side front case 110. FIG. 2 is an exploded perspective diagram of the fixed side front case 110 included in the fixed side housing 100 illustrated in FIG. 1. FIG. 3 is a perspective diagram illustrating a combination of a light guiding sheet member, a dome sheet, and a circuit board. FIG. 4 is an explanatory diagram explaining an attached state of a light shielding sheet. FIG. 5 is an enlarged cross-section diagram of a main part of FIG. 1.

As illustrated in FIG. 2, the operation panel 115 with the plurality of numeric keys 111 is allocated on an upper surface of the fixed side front case 110. As illustrated in FIG. 2, in the inner part of the fixed side front case 110, the light guiding sheet member 400, a dome sheet 600, and a circuit board 500 are layered respectively in an order from the top.

The light guiding sheet member 400 is formed to have substantially the same shape and size as those of the fixed side front case 110. At corners of a body part 410 of the light guiding sheet member 400, an attaching part 420 and an attaching part 430 are provided. In the body part 410, a plurality of circular convex surface parts 411 that substantially coincide with the positions where the numeric key 111 is formed.

Since the thickness dimension of the light guiding sheet member 400 is influenced by pressure applied to the numeric key 111 of the operation panel 115, a thin-walled sheet member is selected as the light guiding sheet member 400. This makes it possible to guide the light emitted from the light emitting element (LED) 700 to the lower part of the operation panel 115 and to diffuse the light in a surface shape.

The dome sheet 600 is formed to have substantially the same shape and size as those of the light guiding sheet member 400. At corners of the body part 610 of the dome sheet 600, an attaching part 620 and an attaching part 630 are provided.

As illustrated in FIG. 3, by matching the positions of the attaching parts 420 and 430 of the light guiding sheet member 400 and the positions of the attaching parts 620 and 630 of the dome sheet 600, the light guiding sheet member 400, the dome sheet 600, and the circuit board 500 may be combined.

In the body unit 610 of the dome sheet 600, a plurality of circular convex surfaces 611 that substantially coincide with the positions where the numeric key 111 is formed. The dome sheet 600 is provided with a disc spring. Conduction of a connection point P (FIG. 5) becomes effective (OK) by the disc spring based on pressing of the numeric key 111 of the operation panel 115.

The light shielding sheet 350 has a pair of attaching pieces 352 (FIG. 4) by which the body part 351 shielding against the light emitted from the light emitting element (LED) 700 and the shielding sheet 350 are attached to the circuit board 500. The light emitted from the light emitting element (LED) 700 is light other than the light guided by the light guiding sheet member 400. The attaching pieces 352 are illustrated in FIG. 4.

The inner part of the light shielding sheet 350 has a three-layered structure having a black sheet member made of a black material with high light shielding ability, a white sheet member made of a white material with high light diffusivity, and an adhesive sheet member having an adhesive layer. Since the black sheet member is positioned at the surface, the light shielding sheet 350 prevents the light emitted from the light emitting element (LED) 700 from leaking out.

The circuit board 500 is formed in a flat shape. At one end side of the body unit 510, a concave surface part 520 with two concave surfaces 522 and 523 at a leading edge part is formed. The pair of attaching pieces 352 (FIG. 4) of the light shielding sheet 350 is engaged with these two concave surfaces 522 and 523 in the concave surface part 520. This makes it possible to attach the light shielding sheet 350 in a given position of the circuit board 500. At one end side of the circuit board 500, two light emitting elements (LED) 700 are provided to illuminate the operation panel 115 from the lower side by the two light emitting elements 700.

As illustrated in FIG. 5, the light emitted from the light emitting element (LED) 700 is guided into between the lower position of the operation panel 115 and the dome sheet 600 by the light guiding sheet member 400, and the light is diffused in a surface shape in the lower part of the operation panel 115. This makes it possible to efficiently illuminate a panel screen of the operation panel 115 by the small number of the light emitting elements (LED) 700.

As described above, according to an embodiment, two light emitting elements (LED) 700 are provided at one end side of the operation panel 115 for illumination of the operation panel 115. However, the number of the light emitting elements (LED) 700 is not limited to two. Moreover, for example, two light emitting elements (LED) 700 may be provided respectively at both end sides of the operation panel 115. This makes it possible to illuminate the operation panel 115 from the lower side by using the light of the light emitting elements (LED) 700 in a wider range.

As described above, the mobile phone 10 according to an embodiment includes, in the inner part of the movable side housing 200 of the mobile phone 10, the two light emitting elements (LED) 700 provided at one end side of the operation panel 115 in which the plurality of numeric keys 111 are arranged, and includes the light guiding sheet member 400 that guides the light emitted from these light emitting emission elements 700 to the lower position of the operation panel 115 and that diffuses the light in a surface shape. Accordingly, the emission part may be illuminated by the small number of light sources and may effectively illuminate the panel screen of the operation panel 115 having the numeric key. This enables reduction of a number of components such as the light emitting element (LED) 700 to be used.

The present embodiment describes the example to be applied to a mobile phone that is foldable via a hinge. The mobile phone according to the present embodiment is also applicable to various hinge structures. For example, the present embodiment is applicable to a mobile phone having a connection structure of a sliding type or a turning type.

The present embodiment describes the example to be applied to a mobile phone as a mobile terminal device. The present embodiment is also applicable to various mobile terminal devices such as a small-sized information processing terminal device like a Personal Digital Assistant (PDA), a small-sized music playing device, a portable television, and a portable game player.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although a few embodiments have been shown and described in detail, it should be understood that various changes, substitutions, and alterations could be made hereto without departing from the spirit and scope of the invention, the scope of which is defined in the claims and their equivalents.

What is claimed is:

1. A mobile terminal device, comprising:
a movable side housing; and
a fixed side housing connected with the movable side housing with a connection part, the fixed side housing including:
an operation panel in which a plurality of numeric keys are arranged;
a light emitting element that is provided at one end side of the operation panel; and
a light guiding sheet member that guides light emitted from the light emitting element to a lower position of the operation panel and diffuses the light in a surface shape.

2. The mobile terminal device according to claim 1, wherein an upper part of the light emitting element is provided with a light shielding sheet member that shields against light emitted towards the light guiding sheet member.

3. The mobile terminal device according to claim 2, the light shielding sheet member comprising:
a black sheet member made of a black material with high light shielding ability, and
a white sheet member made of a white material with high light diffusivity, where the white sheet member is facing the light guiding sheet member.

4. The mobile terminal device according to claim 1, the light guiding sheet member is slightly larger than an entire shape of the operation panel.

5. The mobile terminal device according to claim 1, the light guiding sheet member is a thin-walled sheet member.

6. A mobile terminal device, comprising:
an operation panel in which a plurality of keys are arranged; and
a light guiding sheet guiding light emitted from a light emitting element provided at one end side of the operation panel into between a lower position of the operation panel.
